(19) United States
(12) Patent Application Publication
(10) Pub. No.: US 2009/0005930 A1
(43) Pub. Date: Jan. 1, 2009

(54) Level sensing and display system

(76) Inventor: Arthur W. Koebrick, Bakersfield, CA (US)

Correspondence Address: LAW OFFICES OF ERIC KARICH, 2807 ST. MARK DR., MANSFIELD, TX, 76063, US

(21) Appl. No.: 11/823,252

(22) Filed: Jun. 27, 2007

(51) Int. Cl. G05D 9/00

(52) U.S. Cl. 701/36

(57) ABSTRACT

A level sensing and display system for monitoring a plurality of tanks using sensors has a control board with a processor, and a programmable system device having a memory operably installed on the control board. The system further includes a plurality of electrical connectors for operably connecting the control board to the sensors; a display operatively connected to the control board; controls for operably controlling the function of the control board; and a data port operably connected to the control board for uploading customized settings to the memory of the control board, so that the control board can receive data from the sensors and report the data on the display.

### CROSS-REFERENCE TO RELATED APPLICATIONS

Not Applicable

### STATEMENT REGARDING FEDERALLY SPONSORED RESEARCH

Not Applicable

### BACKGROUND OF THE INVENTION

1. Field of the Invention

This invention relates generally to level sensing and display systems, and more particularly to a tank level indicator that can be automatically customized based upon the make and model of the vehicle into which the tank level indicator is being installed.

2. Description of Related Art

It is important to the operation of a vehicle such as a recreational vehicle (“RV”) that the user periodically monitor the status of water tanks on board the RV, so that fresh water tanks can be filled before they run empty, and waste water tanks can be emptied before they overflow. One embodiment of such a waste management system is illustrated in Grech, U.S. 1603/0033664.

Prior art level sensing and reporting systems must be customized to a particular RV. Not only does this force dealers to carry large amounts of extra inventory, it also makes modifying the sensor and reporting system

The above-described references are hereby incorporated by reference in full.

The prior art teaches level sensing and display systems. However, the prior art does not teach a level sensing and display system that can be custom programmed for any RV, boat, or other vehicle or vessel. The present invention fulfills these needs and provides further related advantages as described in the following summary.

### SUMMARY OF THE INVENTION

The present invention teaches certain benefits in construction and use which give rise to the objectives described below.

The present invention provides a level sensing and display system for monitoring a plurality of tanks using sensors. The level sensing and display system includes a control board having a processor, and a programmable system device having a memory operably installed on the control board. A plurality of electrical connectors operably connect the control board to the sensors. A display operatively is connected to the control board. The system further includes controls for operably controlling the function of the control board; and a data port operably connected to the control board for uploading customized settings to the memory of the programmable system device, so that the control board can receive data from the sensors and report the data on the display.

A primary objective of the present invention is to provide a level sensing and display system having advantages not taught by the prior art.

Another objective is to provide a level sensing and display system that includes a control board having a processor and a programmable system device having a memory that can be modified using software from a memory stick.

Another objective is to provide a level sensing and display system that can be automatically customized based upon the make and model of the vehicle into which the system is being installed.

Another objective is to provide a system that enables manufacturers and retailers to quickly and easily modify and customize a tank monitor device of the system so that the system works with a particular make and model of vehicle.

A further objective is to provide a tank monitor device that may be customized to display a splash screen designed by the manufacturer or retailer of the vehicle.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

The accompanying drawings illustrate the present invention. In such drawings:

FIG. 1 is a side elevational view of a recreational vehicle having a level sensing and display system according to a preferred embodiment of the present invention;

FIG. 2 is a top plan view of a tank monitor device of the level sensing and display system, including a display and control buttons for operatively controlling the level sensing and display system;

FIG. 3 is a block diagram of the level sensing and display system illustrating how a memory stick operatively engages a data port for programming the level sensing and display system;

FIG. 4 is a front elevational view of a computer adapted to receive a memory stick for programming the memory stick, and a computer screen upon which is displayed a customization program; and

FIG. 5 is one embodiment of a database created by the customization program.

### DETAILED DESCRIPTION OF THE INVENTION

The above-described drawing figures illustrate the invention, a level sensing and display system 10 in a vehicle 16 for monitoring a plurality of tanks 12 using sensors 14.

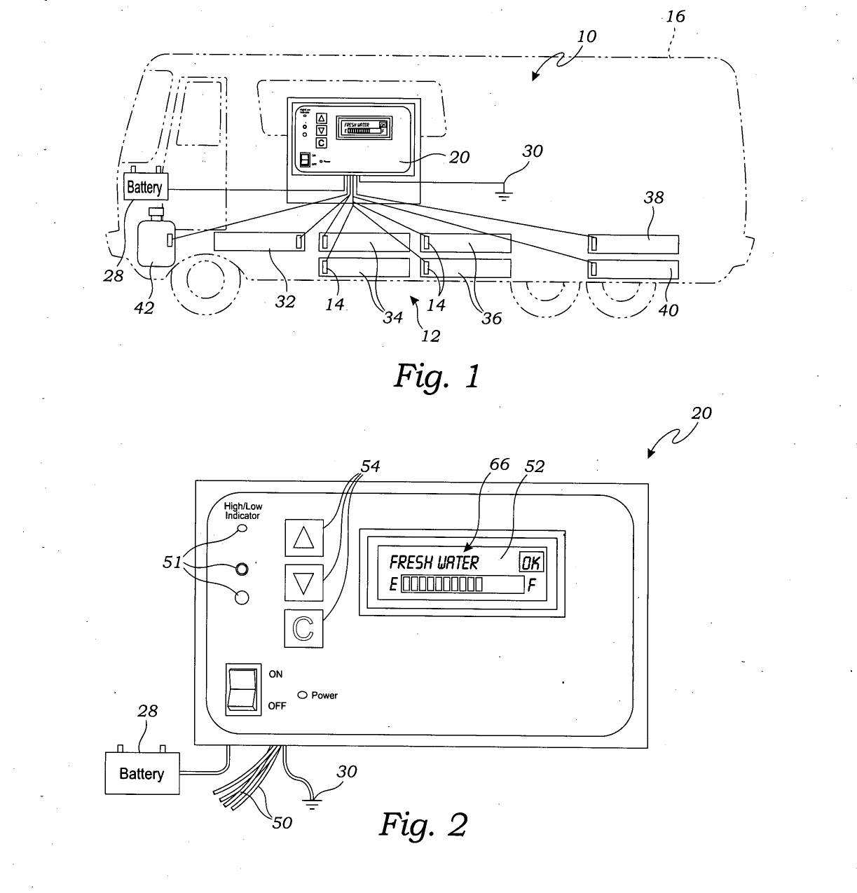

FIG. 1 is a side elevational view of a vehicle 16, in this embodiment a recreational vehicle (or “RV”), having the level sensing and display system 10 according to a preferred embodiment of the present invention. While the level sensing and display system 10 is useful in an RV 16, it may also be used in boats, airplanes, or any other vessels or vehicles that include tanks or similar systems that may need to be monitored.

As shown in FIG. 1, the level sensing and display system 10 includes a tank monitor device 20 that is adapted to be operably connected to the sensors 14 that are operably installed in or on each of the plurality of tanks 12 to be monitored. The tank monitor device 20 is electrically connected to a power source 28, such as a battery of the RV 16, and to a ground 30. In one embodiment, at least one of the sensors 14 may be a circuit board sensor operably mounted to the exterior of one of the plurality of tanks 12 for measuring the amount of fluid in the tank. In another embodiment, at least one of the sensors 14 may be a conductive rod that is positioned within one of the plurality of tanks 12 for measuring the amount of fluid in the tank. The sensor 14 may also be any of a variety of sensors 14 adapted for measuring or otherwise monitoring propane tanks 42, or any other storage device in the RV 16 or other vessel. These and any other similar, equivalent, or related sensors 14 may be used, and should be considered within the scope of the present invention. Since such sensors 14 are well known in the art, they are not described in greater detail herein.

In addition to reporting the status of the tanks 12 (and also including the propane tank 42 and similar storage units), the system 10 can also report the status of the battery 28, and sound an alarm if the battery charge drops below a predetermined level. The status of the battery 28 is reported on the display 52 in a manner similar to the status of the tanks 12.

In the embodiment of FIG. 1, the plurality of tanks 12 includes a gray water storage tank 32, two fresh water tanks 34, two black water tanks 36, a rear fresh water tank 38, a rear gray water tank 40, and a propane tank 42. Each of the tanks 32, 34, 36, and 38 has a suitable sensor 14, and each sensor 14 is operably connected to the tank monitor device 20, either electronically, wirelessly, or otherwise. While one embodiment is illustrated, those skilled in the art will recognize that any number of combinations of various forms of tanks 12 may be used, and that any particular combination of tanks may be monitored using the tank monitor device 20. The method of customizing the tank monitor device 20 to an individual's RV 16 is discussed below.

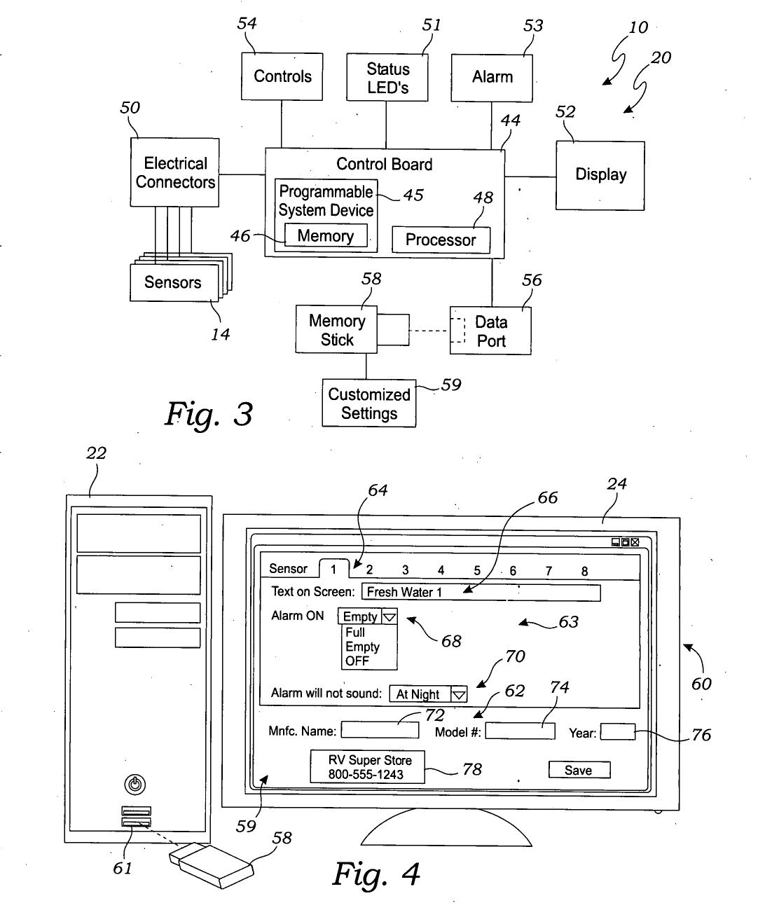

FIG. 2 is a top plan view of the tank monitor device 20 of the level sensing and display system 10, and FIG. 3 is a block diagram thereof. As illustrated in FIGS. 2 and 3, the tank monitor device 20 includes a control board 44. The control board 44 includes a programmable system device 45 with a memory 46 (RAM, ROM, and/or similar memory devices that may be selected by one skilled in the art), and a processor 48. The control board 44 further includes a plurality of electrical connectors 50 for operably connecting the control board 44 to the sensors 14, a display 52 operatively connected to the control board 44, controls 54 for operably controlling the function of the control board 44, and a data port 56.

The control board 44 is preferably a printed circuit board (PCB) of standard construction, as is the processor 48 mounted on the PCB 44. The plurality of electrical connectors 50 that operably connect the control board 44 to the sensors 14 may be electrically conductive wires as are well known in the art, or they may include various more advanced and/or wireless constructions. Since the design and construction of these components are well known to those skilled in the art, they are not described in greater detail herein.

Importantly, the programmable system device 45 with suitable memory 46 enables the control board 44 to be reprogrammable, as described in greater detail below.

The display 52 may be a simple two-line, black-and-white LCD screen, as illustrated, or it may include a larger, color screen, or any other form of display 52 known in the art. The controls 54 may include simple control buttons, as illustrated, but they are hereby defined to include any form of control device known in the art, including any number of buttons, knobs, switches, an attached keyboard, mouse, a separate hand-held controller, or any other mechanism known in the art, including voice commands, and/or any other form of controlling the operation of the system.

The data port 56 is operably connected to the control board 44 and adapted to receive a memory stick 58 for uploading customized settings to the memory 46 of the control board 44, so that the control board 44 can receive data from the sensors 14 and report the data on the display 52. The data port 56 is preferably a USB connection, but is hereby defined to include any form of connection, including but not limited to serial ports, parallel ports, FireWire® , a wireless connection, a proprietary connection, or any other form of connection useful for transferring data to the control board 44.

The memory stick 58 is preferably a portable memory device, also known as a “thumb drive.” The term memory stick 58 is hereby defined to include any form of memory device capable of storing and transferring the customized settings to the control board 44. In another embodiment, the memory stick 58 may be a dongle, and the data port 56 may be any form of connection that receives the dongle, either temporarily or permanently. For purposes of this application, the term memory stick 58 is expressly defined to include a dongle used to authenticate software already stored on the memory 46 of the control board 44, and the relevant terminology is expressly defined to include this alternative.

The tank monitor device 20 may also include status LEDs 51 for indicating the status of the device 20, and may further include an alarm 53 for alerting the user when a tank 12 becomes too full or too empty. The alarm 53 may be an audible alarm, and/or flashing LEDs, and/or any other system that alerts the user, including wireless alerts to electronics devices owned by the user, such as a cell phone. Further details of the function of the alarm 53 are described in greater detail below.

The tank monitor device 20 functions to periodically check the sensors 14 to determine the status of the plurality of tanks 12 being monitored, and update the status shown on the display 52. There is no need for the user to periodically remember to refresh the system 10.

FIG. 4 is a front elevational view of a computer 22 adapted to receive the memory stick 58, and a computer screen 24 upon which is displayed a customization program 60 for creating the customized settings 59. The computer 22 preferably includes a port 61, such as a USB port, for receiving the memory stick 58, but any method of connecting the memory stick 58 with the computer 22 should be considered within the scope of the present invention.

As illustrated in FIG. 4, the customization program 60 receives a vehicle model number 62, which preferably includes a manufacturer's name 72 and a model number 74, and may also include a year 76 of manufacture. While one embodiment of the vehicle model number 62 is illustrated, the vehicle model number 62 may be any reference name, number, or other distinguishing title that is suitable for specifying a certain arrangement of sensors 14. Each of the customized settings 59 is programmed for each of the sensors 14 associated with the vehicle model number 62.

In the embodiment of FIG. 4, each sensor 14 is assigned settings 63 that may include a sensor number selector 64, a title 66 assigned to each sensor 14, an alarm control 68 that enables customization of the control of the alarm 53 (shown in FIG. 1), such as when the alarm 53 sounds, and other features. For example, the tank 12 associated with the selected sensor 14 would trigger the alarm 53 when it is nearing full when the tank is for waste water, but when the tank 12 contains fresh water, the alarm 53 would be set to go off when the tank is nearing empty. The alarm 53 may also be triggered if the charge in the battery 28 drops below a predetermined level.

The alarm 53 might also be turned off in some circumstances. For example, a night standby control 70 may enable the user to specify whether the alarm 53 should sound at night, or whether it should be disabled between certain hours to as to not disturb the users. The customization program 60 enables all of the settings 63 to be made for the sensors 14 for the plurality of tanks 12. In the present embodiment, the system 10 can be used to track up to eight sensors 14; however, in alternative embodiments, the system 10 may be used to track any number of sensors 14, depending upon the needs of the vehicle 16.

The settings 63 may also include additional information. For example, the settings 63 may include a “splash screen” 78 that enables a retailer to create a custom message for the user when suitable (for example, when the system 10 is turned on, or reset, or in a rest mode). This enables additional flexibility to the retailer or manufacturer, and provides an important customer relations and customer service tool.

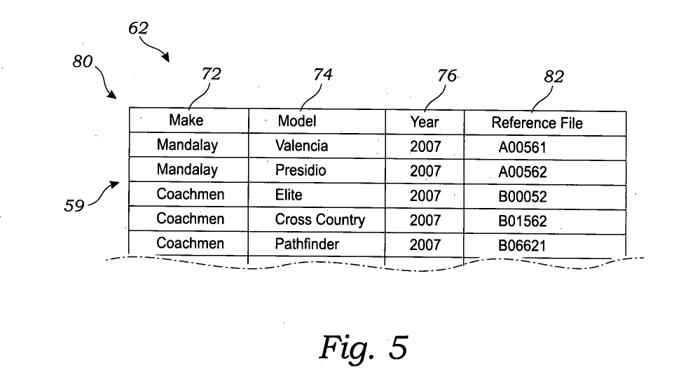

The customization program 60 preferably creates the customized settings 59 by linking the vehicle model number 62 with a reference file 82 that includes pre-programmed settings 63 for interfacing with each of the sensors 14 of that specified vehicle 16. FIG. 5 illustrates one embodiment of a database 80 created by the customization program 60 (of FIG. 4). In this embodiment, the database 80 links the manufacturer's name 72.(a “Make”), the model number 74 (a “Model”), and the years 76 of manufacture, with a reference file 82 that contains the settings 59 appropriate for that vehicle 16. For example, if the vehicle 16 of a certain make, model, and year, has a certain variety of tanks and other items that are monitored, all of these settings are programmed into the settings 63 associated with that make, model, and year.

The invention further includes a method for monitoring the plurality of tanks 12 using the above-described level sensing and display system 10, illustrated in FIGS. 1-5. The level sensing and display system 10 is first installed in the vehicle 16, using techniques known to those skilled in the art. The tank monitor device 20, including the display 52 and the controls 54, is preferably mounted for easy access within the RV 16 and as close as possible to the plurality of tanks 12.

Each of the sensors 14 is installed on one of the plurality of tanks 12 (it not already done so), and then the sensor is operatively connected with one of the plurality of electrical connectors 50 of the control board 44. In the preferred embodiment, the sensors 14 are already installed during the manufacture of the RV 16, and the retail establishment merely connects the control board 44 to the sensors 14. The sensor 14, such as a 90 ohm sending unit, may also be attached to the propane tank 42 if a sensor is not already attached.

The memory stick 58, pre-programmed with the plurality of customized settings 59 using the computer 22, is inserted into the data port 56, and one of the plurality of potential vehicle model numbers 62 is selected that corresponds to the vehicle 16. The tank monitor device 20 then functions to upload the customized settings 59 to the memory 46 of the control board 44 via the data port 56, so that the control board 44 can receive data from the sensors 14 and report the data on the display 52.

Even once the system 10 has been programmed, it remains easily possible to add additional sensors 14 for monitoring additional tanks 12, propane tanks 42, or other items that require upkeep and/or monitoring. The appropriate one of the plurality of electrical connectors 50 is simply attached to the new sensor 14, and the controls can be used to associate a new title and other settings with that sensor 14. This represents a great improvement over the prior art devices, which typically must be replaced to add a new tank or change the configuration.

The terminology used in the specification provided above is hereby defined to include similar and/or equivalent terms, and/or alternative embodiments that would be considered obvious to one skilled in the art given the teachings of the present patent application. Additionally, the words “a,” “an,” and “one” are defined to include one or more of the referenced item unless specifically stated otherwise. Also, the terms “have,” “include,” “contain,” and similar terms are defined to mean “comprising” unless specifically stated otherwise.

While the invention has been described with reference to at least one preferred embodiment, it is to be clearly understood by those skilled in the art that the invention is not limited thereto. Rather, the scope of the invention is to be interpreted only in conjunction with the appended claims.

What is claimed is:

1. A level sensing and display system for monitoring a plurality of tanks using sensors, the level sensing and display system comprising:
a control board having a processor
a programmable system device having a memory operably installed on the control board;
a plurality of electrical connectors for operably connecting the control board to the sensors;
a display operatively connected to the control board;
controls for operably controlling the function of the control board; and
a data port operably connected to the control board for uploading customized settings to the memory of the programmable system device, so that the control board can receive data from the sensors and report the data on the display.

2. The level sensing and display system of claim 1, wherein the data port is adapted to receive a memory stick having the customized settings.

3. The level sensing and display system of claim 1, further comprising a customization program for creating the customized settings by linking a vehicle model number with settings for interfacing with each of the sensors.

4. The level sensing and display system of claim 3, wherein the customization program includes a splash screen that enables creation of a custom message on the display.

5. The level sensing and display system of claim 1, wherein the data port is a USB port.

6. The level sensing and display system of claim 1, wherein the controls are a plurality of control buttons.

7. The level sensing and display system of claim 1, further comprising status LEDs.

8. The level sensing and display system of claim 1, further comprising an alarm for signaling when one of the plurality of tanks requires service.

9. The level sensing and display system of claim 8, wherein the customization program includes an alarm control that enables customization of the control of the alarm.

10. A level sensing and display system for monitoring a plurality of tanks using sensors, the level sensing and display system comprising:
a control board having a processor;
a programmable system device having a memory operably installed on the control board;
a plurality of electrical connectors for operably connecting the control board to the sensors;
a display operatively connected to the control board;
controls for operably controlling the function of the control board; and
a memory stick having the customized settings;
a data port operably connected to the control board and adapted to receive the memory stick for uploading the customized settings to the memory of the programmable system device, so that the control board can receive data from-the sensors and report the data on the display.

11. The level sensing and display system of claim 10, further comprising a customization program for creating the customized settings by linking a vehicle model number with settings for interfacing with each of the sensors.

12. The level sensing and display system of claim 10, wherein the plurality of electrical connectors are a plurality of electrically conductive wires extending from the control board.

13. The level sensing and display system of claim 12, wherein the customization program includes a splash screen that enables creation of a custom message on the display.

14. The level sensing and display system of claim 10, wherein the data port is a USB port.

15. The level sensing and display system of claim 10, wherein the controls are a plurality of control buttons.

16. The level sensing and display system of claim 10, further, comprising an alarm for signaling when one of the plurality of tanks requires service.

17. A method for monitoring a plurality of tanks on a vehicle, the method comprising the steps of:
providing a level sensing and display system comprising:
a control board having a processor;
a programmable system device having a memory operably installed on the control board;
a plurality of electrical connectors operably connected to the control board;
a display operatively connected to the control board;
controls for operably controlling the function of the control board; and
a data port operably connected to the control board;
installing the level sensing and display system in the vehicle having sensors operably installed on the plurality of tanks to be monitored;
operably connecting each of the sensors with one of the plurality of electrical connectors;
providing a memory stick having a plurality of customized settings each associated with one of a plurality of potential vehicle model numbers;
inserting the memory stick into the data port;
selecting the one of the plurality of potential vehicle model numbers that corresponds to the vehicle; and
uploading the one of the customized settings that corresponds to the selected one of the plurality of potential vehicle model numbers, to the memory of the programmable system device via the data port, so that the control board can receive data from the sensors and report the data on the display.

18. The method of claim 17 further comprising the steps of:
providing a customization program for creating the customized settings by linking a vehicle model number with settings for interfacing with each of the sensors; and
programming each of the customized settings for each of the sensors associated with the vehicle model number.

19. The method of claim 18, wherein the customization program includes a splash screen, and further comprising a step of creating of a custom message to be displayed on the display.
